(19) United States
(12) Patent Application Publication
(10) Pub. No.: US 2009/0008196 A1
(43) Pub. Date: Jan. 8, 2009

(54) Multistage Adjusting Device

(75) Inventors: Yasuyoshi Suzuki, Shizuoka (JP); Shingo Shibayama, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: SOQI H.S KABUSHIKI KAISHA, Shizuoka-ken (JP)

(21) Appl. No.: 12/119,318

(22) Filed: May 12, 2008

(30) Foreign Application Priority Data
Feb. 6, 2007 (JP) 2007-026263

(51) Int. Cl. F16F 9/44

(52) U.S. Cl. 188/285

(57) ABSTRACT

A cylindrical body, a plurality of grooves formed on an inner wall surface of the cylindrical body, and a device main body provided with an adjusting body disposed in the cylindrical body and rotatable in an inner circumferential direction of the cylindrical body can be provided. Further, the grooves can be formed continuously or intermittently along a longitudinal direction of the cylindrical body. A plurality of control members can be disposed along a longitudinal direction of the adjusting body. The control member can be provided with a ball projected from a side surface of the adjusting body and urged to engage with the grooves. At least one ball provided for one control member can be located between adjacent grooves and a ball provided for another control member can be engaged with one of the groove.

### CROSS-REFERENCE TO RELATED APPLICATIONS

This application is based upon Japanese Patent Application Serial No. 2007-026263, filed Feb. 6, 2007, the entire contents of which is hereby incorporated by reference.

### BACKGROUND OF THE INVENTIONS

1. Field of the Inventions

The present inventions relate to multistage adjusting devices for adjusting an amount of rotation, for example, of an opening adjusting mechanism of a needle valve for a damping force adjustment of a damper mechanism that can be used as a shock absorber of a straddle-type vehicle.

2. Description of the Related Art

The resistance caused by a pressure differential in a cylinder is often used as a damping force control of a hydraulic damper. The pressure difference is produced on the contraction side and on the expansion side of a piston provided in the cylinder. A piston rod usually extends from the piston so as to connect the piston with another device.

A damping force adjusting rod is often axially and movably inserted in the axial center of the piston rod. A conical needle valve is provided at an end of the damping force adjusting rod. When the piston is moved toward the contraction side, oil passes through a passage in the piston rod. Accordingly, the damping force can be adjusted by adjusting an opening degree of the needle valve.

Japanese Patent Document JP-A-Hei 11-287279 discloses such a damping force adjusting device of a hydraulic damper in which damping force is adjusted by using such a needle valve. This damping force adjusting device adjusts an amount of reciprocating movement of the adjusting rod so that a throttle angle of an opening area of a bypass flow passage can be finely adjusted. In this design, an adjuster in an adjuster holder is rotated and thus provides fine adjustment. The adjuster is rotationally operated to engage a ball provided in the adjuster with a plurality of engaging recesses disposed at a plurality of positions in a circumferential direction of the adjuster holder. As such, the ball can engage the recesses and provide a positive feel of engagement in a plurality of predetermined positions (see paragraph 0019 of the JP-A-Hei 11-287279 patent document).

### SUMMARY OF THE INVENTIONS

An aspect of at least one of the embodiments disclosed herein includes the realization that, according to the damping force adjusting device described in JP-A-Hei 11-287279, when it is desired to reduce spaces between engaging positions of the adjuster, e.g., to provide for finer adjustments, the number of the engaging recesses needs to be increased. A size of a hydraulic damper, however, such as those for a vehicle bodies such as a motorcycles, can be limited. Accordingly, it is not always practical to increase the number of the engaging recesses of the adjuster holder because of the increase in size that would result.

On the other hand, when the adjusting rod is moved by a rotation of the adjuster, an end of the adjusting rod is pressed via a screw member perpendicular to the adjusting rod by a tapered surface at a lower end of the screw member in an adopted constitution. In this case, a space between screw threads is made small to enable a fine adjustment so that a fine feeling of engagement can be felt. However, a space between screw threads needs to be of a certain size from a viewpoint of a structure or strength in certain environments, such as vehicles, which can also have space limitations, such as motorcycles.

Another known technique for providing finer adjustment is a making an angle at an end of the needle valve an acute angle to achieve a fine adjustment of an opening angle. However, if the angle at the end of the needle valve is too acute, the needle valve may be stuck.

Another aspect of at least one of the inventions disclosed herein includes the realization that multistage adjustment devices can achieve finer adjustment steps by providing multiple engagement devices that are offset such that when one engagement device is engaged with a groove, for example, the other is between grooves. As such, the device can provide twice the number of engagement positions without adding any more grooves.

Thus, in accordance with an embodiment, a multistage adjusting device can comprise a cylindrical body and a plurality of grooves formed on an inner wall surface of the cylindrical body, the plurality of grooves being continuous or intermittent along a longitudinal direction of the cylindrical body. A device main body can be provided with an adjusting body disposed in the cylindrical body and rotatable in an inner circumferential direction of the cylindrical body. At least first and second control members can be disposed along a longitudinal direction of the adjusting body. The first and second control members can be provided with at least a first and second balls, respectively, the first and second balls projecting from a side surface of the adjusting body and urged toward engagement with the grooves. The first and second control members can be arranged such that at least first ball is located between adjacent grooves when the second ball is engaged with one of the grooves.

Additionally, a multistage adjusting device can comprise a cylindrical body and a plurality of grooves formed on an inner wall surface of the cylindrical body, the plurality of grooves being continuous or intermittent along a longitudinal direction of the cylindrical body. A device main body can be provided with an adjusting body disposed in the cylindrical body and rotatable in an inner circumferential direction of the cylindrical body. At least first and second control members can be disposed along a longitudinal direction of the adjusting body, the first and second control members including first and second engagement means, respectively, for engaging the plurality of grooves. The first and second engagement means can be arranged such that at least the first engagement means is located between adjacent grooves when the second engagement means is engaged with one of the grooves.

### BRIEF DESCRIPTION OF THE DRAWINGS

The above-mentioned and other features of the inventions disclosed herein are described below with reference to the drawings of preferred embodiments. The illustrated embodiments are intended to illustrate, but not to limit the inventions. The drawings contain the following Figures:

FIG. 1 is a cross-sectional view of a multistage adjusting device according to an embodiment.

FIG. 2 is a cross-sectional view of a modification of the multistage adjusting device.

FIG. 3 is a schematic partial cross-sectional view of a hydraulic damper to which the above multistage adjusting devices can be applied.

FIG. 4 is a side elevational and partial cross sectional view of FIG. 3.

FIG. 5 is an enlarged sectional-view of the damper in a vicinity of a needle valve.

FIG. 6 is an enlarged cross-sectional view in a vicinity of the multistage adjusting device applied to the hydraulic damper in FIG. 4.

FIG. 7 is a graph showing illustrative examples of characteristics of damping forces resulting from use of the multistage adjusting devices illustrated above with the hydraulic damper in FIG. 4.

FIG. 8 is a schematic view of another hydraulic damper to which the above multistage adjusting devices can be applied.

FIG. 9 is an enlarged cross-sectional view of the hydraulic damper of FIG. 8 in a vicinity of the needle valve.

FIG. 10 is an enlarged cross-sectional view of the hydraulic damper of FIG. 8 in a vicinity of the multistage adjusting.

### DETAILED DESCRIPTION OF THE PREFERRED EMBODIMENT

The figures illustrate various embodiments and applications of multistage adjusting devices. The multistage adjusting devices are illustrated in the context of hydraulic dampening devices, such as those used in vehicles, because they have particular utility in that context. However, the multistage adjusting devices disclosed herein can be used in other contexts, such as, for example, but without limitation, gas-filled dampers, dampers for other devices as well as devices other than dampers.

In some embodiments, the multistage adjusting devices include a cylindrical body, a plurality of the grooves formed on the inner wall surface of the cylindrical body, and a device main body provided with an adjusting body disposed in the cylindrical body and rotatable in the inner circumferential direction of the cylindrical body. The grooves are formed continuously or intermittently along the longitudinal direction of the cylindrical body. A plurality of control members is disposed along the longitudinal direction of the adjusting body. Each control member is provided with the ball projected from the side surface of the adjusting body and biased to engage with the grooves. At least one ball provided for one control member is located between adjacent grooves while a ball provided for another control member is engaged with the groove. Accordingly, engaging positions of a rotating body rotationally operated in a member having a limited size can be finely set in a simple structure, and the multistage adjusting device can be preferably used for a damping force adjustment of a hydraulic damper.

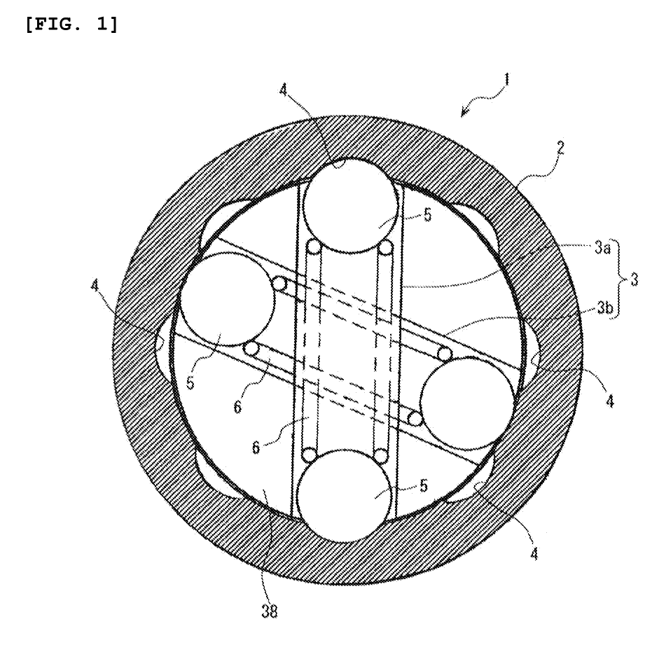

As illustrated in FIG. 1, a multistage adjusting device 1 can include an adjusting body 38 provided with a cylindrical body 2 and a control member 3. A plurality of grooves 4 can be formed in radial positions from an axial center on an inner wall surface of the cylindrical body 2. The embodiment of FIG. 1 includes eight grooves at intervals of 45 degrees.

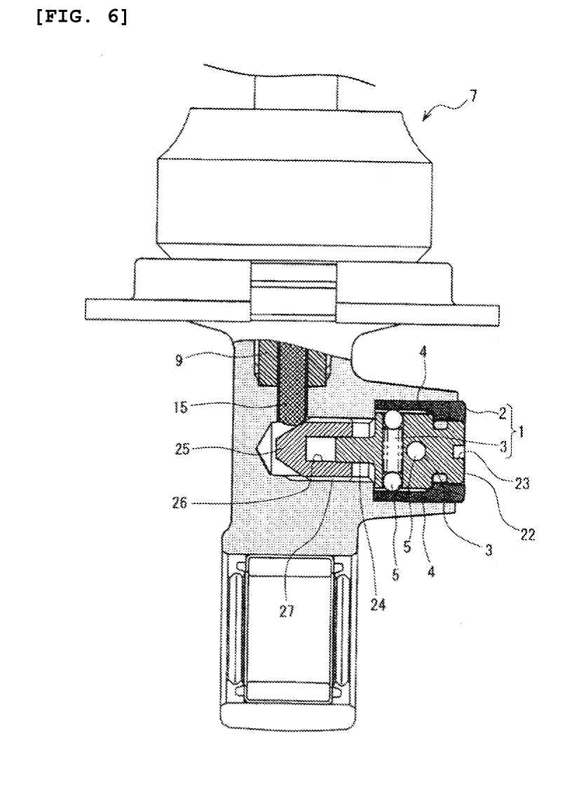

The grooves 4 can be continuously formed along a longitudinal direction of the cylindrical body 2 (see FIG. 6). A ball 5 can be provided on both ends of the control member 3.

The ball 5 can be urged outward by a spring 6, that is, to be engaged with one of the grooves 4. With the ball 5 urged into contact with the inner wall surface of the cylindrical body 2, the control member 3 can rotate around the axial center of the cylindrical body 2. Therefore, as the control member 3 rotates, the ball 5 is engaged with one of the grooves 4.

When the control member 3 is further rotated, the ball 5 is engaged with the next groove 4. In embodiments where a ball 5 is provided at both ends, two of the balls 5 are engaged with the grooves 4 at about the same time. Accordingly, the control member 3 can be more securely held in position, in other words, the balls 5 are less likely to slip out of the groove 4, thereby providing more holding force for maintaining the control member 3 in position. If a rotational shaft of the control member 3 is connected to another mechanical member, the control member 3 can be used in conjunction with various types of control mechanisms.

In some embodiments, a plurality of the control members 3 can be disposed along a longitudinal direction of the adjusting body 38 (two control members 3a, 3b being illustrated in FIG. 1). Additionally, the control members 3a, 3b can be offset relative to each other and the grooves 4 so as to provide additional preset positions in which any of the balls 5 will fall into a groove 4.

For example, the ball 5 of a control member 3b on a far side can be disposed between adjacent grooves 4 and 4 when the ball 5 of a control member 3a on a near side is engaged with the groove 4. Further, a positional relation between the control members 3a and 3b can be mutually fixed, and the control members 3a and 3b can be coaxially rotatable together. Thus, in such a configuration, while the ball 5 of the control member 3a on the near side is moved to the next groove 4 by rotating the control member 3, the ball 5 of the control member 3b on the far side is engaged with the groove 4. Therefore, the control engaging positions can be set more finely than in a case that the control mechanism is constituted with one control member 3 or, in other words, with a single stage mechanism.

Additionally, in some embodiments, the control members 3a, 3b, can be oriented relative to one another so that the balls 5 of both control members 3a, 3b are engaged with grooves 4 at the same time. For example, when the ball 5 of one control member 3 is engaged with the groove 4, if the ball 5 of another control member 3 is also disposed so as to engage another groove 4, a larger number of balls 5 can be engaged with the grooves 4 at the same time. Accordingly, the rotational orientation of the control member 3 can be more securely held in a chosen position because the balls 5 are less likely to slip out of the groove 4.

By including a plurality of the control members 3 with the adjusting body 38 to provide a multistage mechanism, the position of the control member 3 can be finely set without increasing the number of grooves 4 formed on the cylindrical body 2. Therefore, when the size of the cylindrical body 2 is not changeable, or when the size of the cylindrical body 2 is limited, it is possible to finely set the controlling engaging positions in a simple structure with low cost. For example, the control member 3a on the near side in FIG. 1 can make a control device with eight engaging positions. However, sixteen engaging positions can be obtained by providing the control member 3b on the far side, in a position offset from the control member 3a and the grooves, without providing any new grooves 4 or changing the size of the inner cylinder 2.

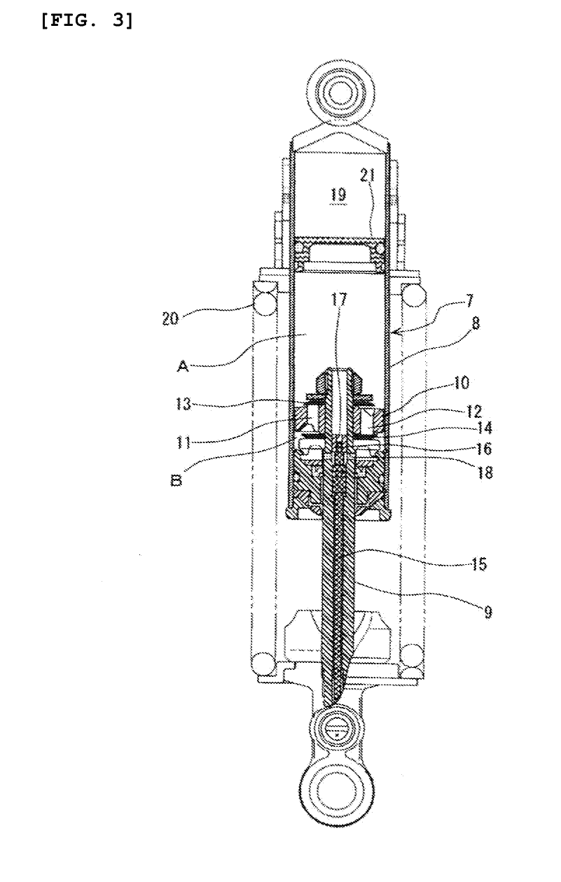

Further, as the ball 5, which is biased outwardly, is engaged with the groove 4, a feeling of engagement with a notch can be felt by the user. Thus, when an adjustment is made by a small amount of rotation, the adjustment is easy for an operator to recognize. For example, the present embodiments can be used as a damping force adjustment mechanism in a suspension system of a motorcycle (see FIG. 3 to FIG. 9), a control mechanism of an opening angle of a valve of a steering damper, or an opening valve pressure control mechanism of an outboard motor, as well as for other functions or applications.

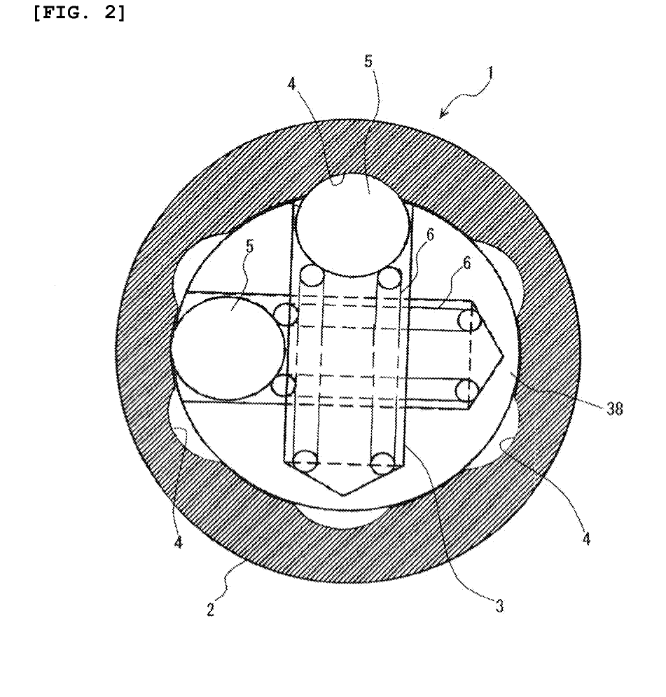

FIG. 2 is a cross-sectional view of a modification of the multistage adjusting device. The multistage adjusting device 1 can have six grooves 4 formed at intervals of 60 degrees and can be provided with one ball 5 in the control member 3. In some embodiments, the control member 3 can include two control members, each having a ball 5 and provided in relation to the adjusting body 38 at an interval of 90 degrees from each other. Even in such a constitution, it is possible to set the control engaging positions, twice as fine without changing the size of the inner cylinder 2 or providing any new grooves 4. Other constitutions, operations, and effects can be the same as those in FIG. 1.

The various embodiments of multistage adjusting devices described above can be applied to, for example, but without limitation, a hydraulic damper, described below in greater detail.

For example, a hydraulic damper can be used to suppress a postural change of a vehicle body caused by roughness on a road surface. Such a vehicle can be a motorcycle. The hydraulic damper can be mounted between a front wheel and the vehicle body and/or between a rear wheel and the vehicle body. In other words, such a hydraulic damper can be mounted between a vehicle body and at least one of a front wheel and a rear wheel.

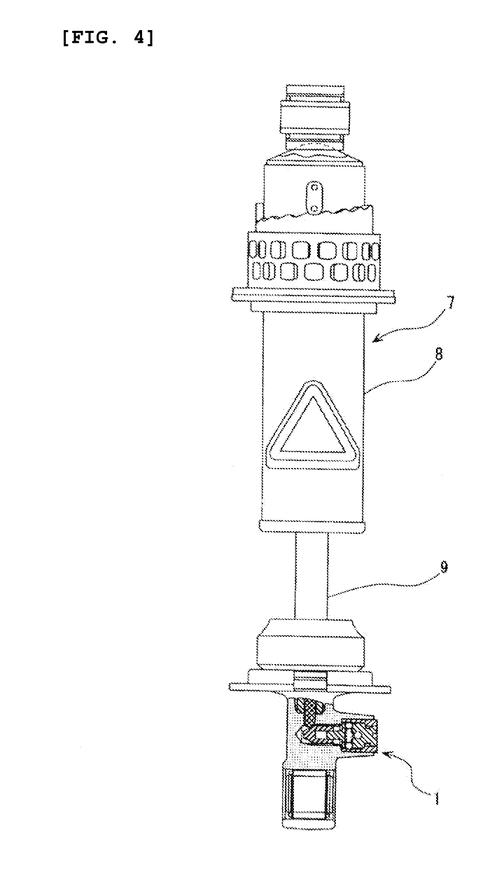

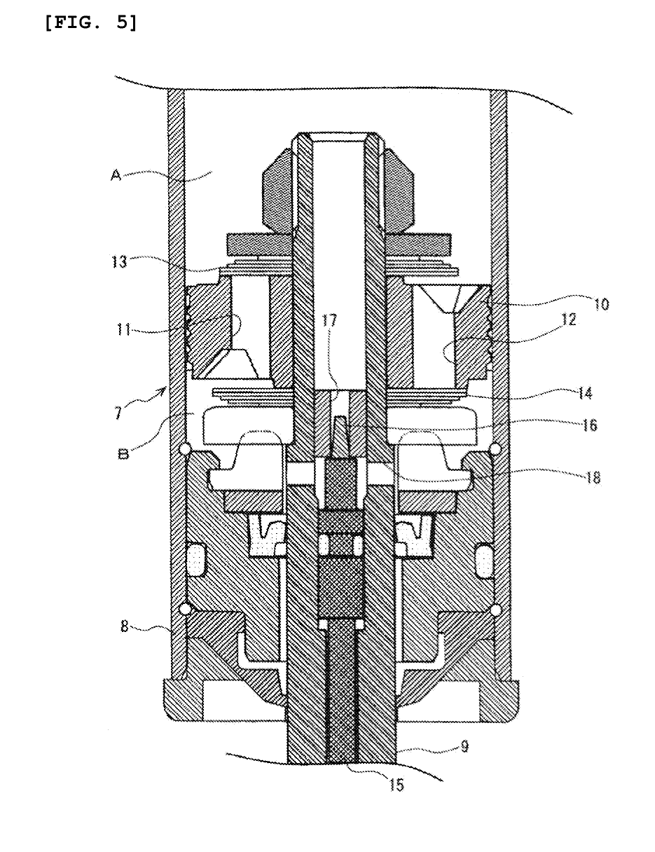

FIG. 3 is a schematic view of a hydraulic damper to which the multistage adjusting devices described above can be applied. FIG. 4 is a side view thereof A part of a cross-sectional view is illustrated in FIG. 3 and FIG. 4. Further, FIG. 5 is an enlarged sectional-view in a vicinity of a needle valve.

Reference number 7 is a hydraulic damper mounted on a rear wheel side of a motorcycle. This hydraulic damper 7 can be constituted with a piston rod 9 movable in a cylinder 8.

An inside of the cylinder 8 can be defined into a contraction side oil chamber A and an expansion side oil chamber B by a piston 10 located at an end of the piston rod 9. A first passage 11 and a second passage 12 connecting the contraction side oil chamber A and the expansion side oil chamber B can be formed in the piston 10.

An expansion side leaf valve 13 opened when the piston rod 9 can be expanded can be provided on the first passage 11, and an contraction side leaf valve 14 opened when the piston rod 9 can be contracted can be provided on the second passage 12. As a result, while the piston 10 affected by roughness on a road surface relatively moves in an axial direction in the cylinder 8, oil in the cylinder 8 passes through the first passage 11 or the second passage 12, generating damping force. An damping operation between the vehicle body and the wheel is achieved also, for example, by high pressure nitrogen gas filled in a gas chamber 19 provided in the cylinder 8 or a coil spring 20 (see FIG. 3). The gas chamber 19 and the contraction side oil chamber A are defined by a free piston 21.

A damping force adjusting rod 15 axially and relatively movable in relation to the piston rod 9 can be provided at an axial center of the piston rod 9. A needle valve 16 generally in a conical shape can be provided at an end of the damping force adjusting rod 15.

The needle valve 16 can be configured to change an opening area of a small hole 17 in the piston rod 9 by reciprocating movement of the adjusting rod 15. When the piston rod 9 is contracted, the oil in the contraction side oil chamber A flows in via the end of the piston rod 9 and moves from a bypass flow passage 18 to the expansion side oil chamber B via the small hole 17. Therefore, damping force can also be generated by adjusting the position of the needle valve 16. The needle valve 16 is biased toward the expansion side by gas pressure in the gas chamber 19.

The amount of reciprocating movement of the needle valve 16 can be adjusted by the multistage adjusting device 1 described above. The multistage adjusting device 1 can be provided at an end of the hydraulic damper 7.

FIG. 6 is an enlarged cross-sectional view of a vicinity of the multistage adjusting device applied to the hydraulic damper in FIG. 4.

As described above, the multistage adjusting device 1 can be provided at the end of the hydraulic damper 7. The multistage adjusting device 1 can be constituted with the cylindrical body 2 and an adjuster (adjusting body) 22 provided with the control member 3.

In FIG. 6, the adjuster 22 is disposed at a position in which two of the control members 3 are orthogonally crossed. The control member 3 rotates with the adjuster 22 in the cylindrical body 2.

The rotation of the adjuster 22 can be performed by engaging a tool such as a flathead screwdriver with a cutout recess 23 provided at an end on one side of the adjuster 22. The grooves 4 are formed continuously along a longitudinal direction of the cylindrical body 2. The grooves 4 can be intermittently provided in positions along the longitudinal direction of the cylindrical body 2 in which the ball 5 of each control member 3 in the multistage mechanism can be engaged.

A boss 24 in a shape of a square pillar can be formed at an end on the opposite side of the adjuster 22 from the cutout recess 23. The boss 24 can be inserted in an insertion hole 26 in the same shape as that of the boss 24 provided in a screw adjuster 25.

The screw adjuster 25 can be threadedly engaged with a threaded part 27 at an end of the hydraulic damper 7 and thus can vertically move an adjusting rod 15 by being rotated. For example, the end of the screw adjuster 25 can be tapered, and a lower end of the adjusting rod 15 can be formed in a spherical shape. Therefore, as the screw adjuster 25 rotates and thus moves linearly toward the adjusting rod 15, the adjusting rod 15 is pushed upwardly along the tapered surface. Therefore, when it is desired to change a damping force by adjusting the reciprocating movement of the needle valve 16, the adjuster 22 can be axially rotated, thereby rotating the screw adjuster 25, which in turn rotates the boss 24.

Since the boss 24 can be in a shape of a square cylinder as described above, the boss 24 can be engaged with the insertion hole 26 in a rotational direction. Accordingly, the rotation of the screw adjuster 25 can follow the rotation of the adjuster 22. As a result, the screw adjuster 25 moves along the threaded part 27. In this configuration, since the boss 24 and the insertion hole 26 can slide relative to each other, the adjuster 22 does not move axially, but only rotates.

As the screw adjuster 25 rotates, the adjusting rod 15 can be pushed upwardly along the tapered surface. This means that the opening angle of the needle valve 16 can be adjusted by the rotational amount of the screw adjuster 25. The adjustment of the rotational amount of the screw adjuster 25 can be performed by the various embodiments of the multistage adjusting device 1 described above.

As described above, the multistage adjusting device can be mounted in relation to the hydraulic damper of the motorcycle whose size is limited. Further, controlling engaging positions can be finely set without newly forming a groove or the like on the cylindrical body. Therefore, the amount of the reciprocating movement of the needle valve 16 can be finely adjusted, and damping force can be finely adjusted.

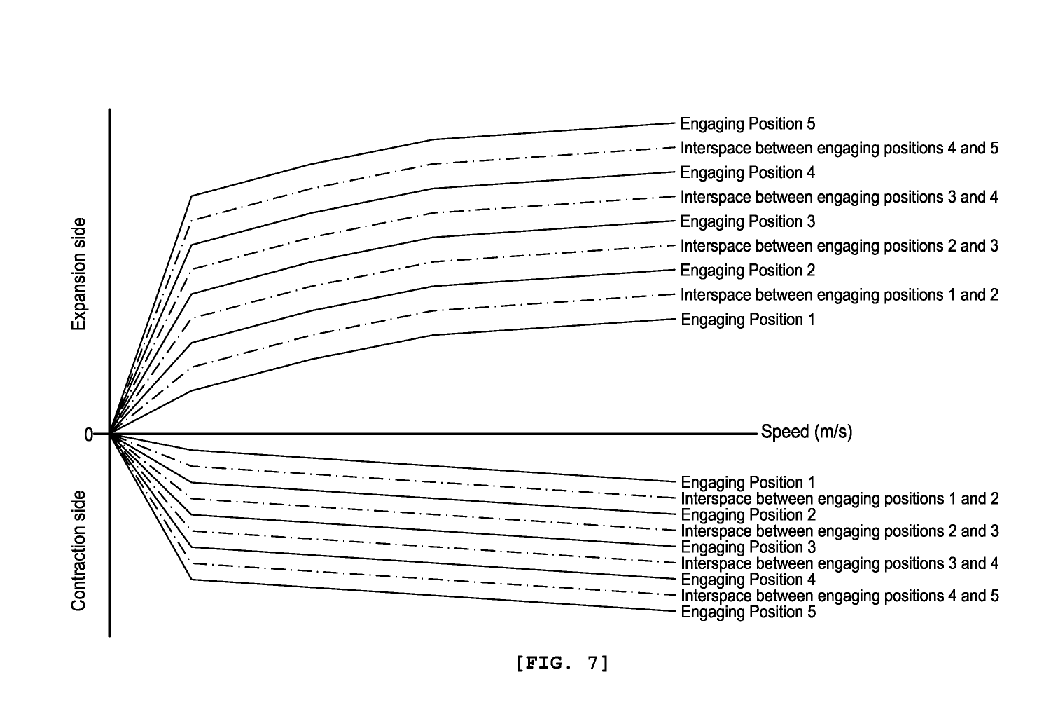

FIG. 7 is a diagram illustrating characteristics of damping force when the multistage adjusting device 1 is applied to the hydraulic damper in FIG. 4.

In the drawing, the abscissa represents moving speed of a piston, the upper half of the ordinate represents damping force on the expansion side, and the lower half of the ordinate represents damping force on the contraction side. Further, solid lines indicate characteristics when a conventional single stage adjusting device having one control member 3 is used. The alternate long and short dash lines indicate characteristics when an adjustment is made with a second control member 3.

As illustrated in the drawing, when the control device having two control members is used, the second control member 3 can be engaged with the groove(s) between positions in which a first control member 3 is engaged with the groove(s). Accordingly, the number of adjusting engaging positions can be increased in comparison that of the adjusting device having one control member. Therefore, finer performance settings can be made by applying the adjusting device to the hydraulic damper of a motorcycle.

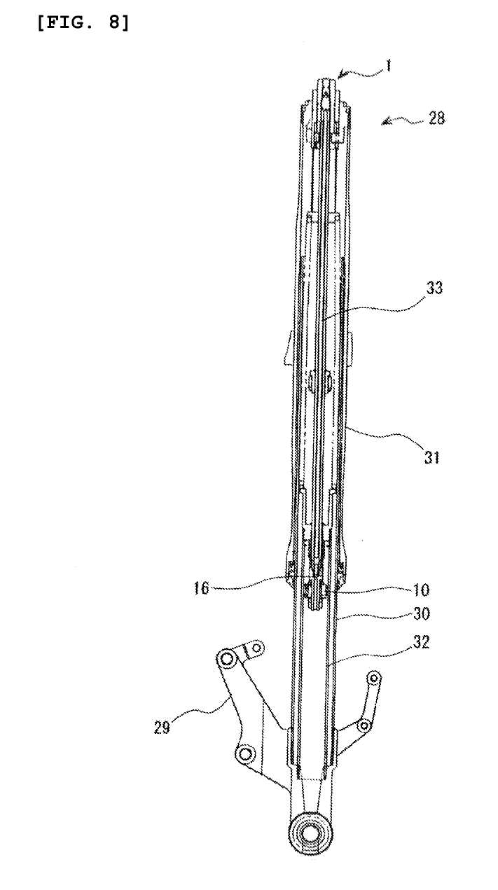

FIG. 8 is a schematic view of another hydraulic damper to which the various embodiments of the multistage adjusting devices described above can be applied.

FIG. 8 illustrates a front fork of a headstand type device attached on a front wheel side of a motorcycle. A front fork 28 can be constituted with an axle bracket 29, an inner tube 30, and an outer tube 31. An inner cylinder 32 filled with oil can be provided in the inner tube 30 generally in a cylindrical shape. An inner rod 33 can be disposed in the inner cylinder 32 to be axially movable. The piston 10 can be provided at a lower end of the inner rod 33. A damper (damping) mechanism can be formed by compressing or expanding the oil filled in the inner cylinder 32 as the piston 10 vertically moves.

The multistage adjusting device 1 can be provided at an upper end of the inner rod 33. The needle valve 16 for adjusting damping force can be provided at a lower end of the inner rod 33.

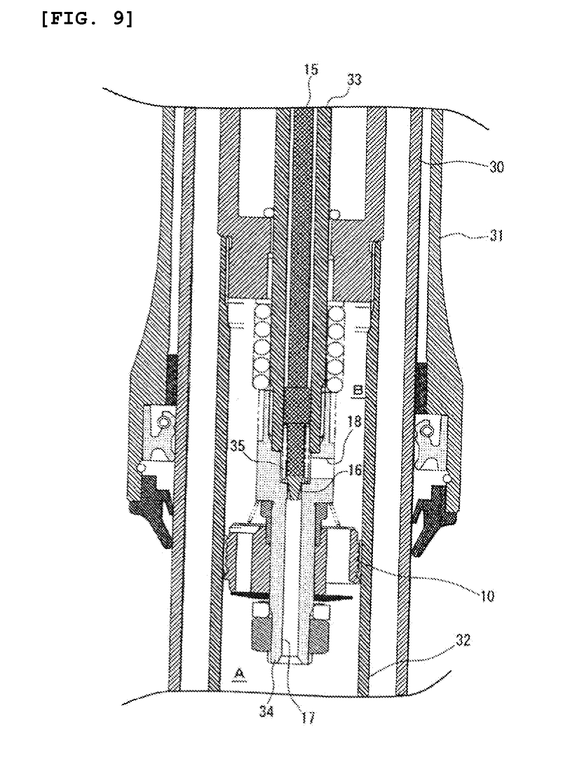

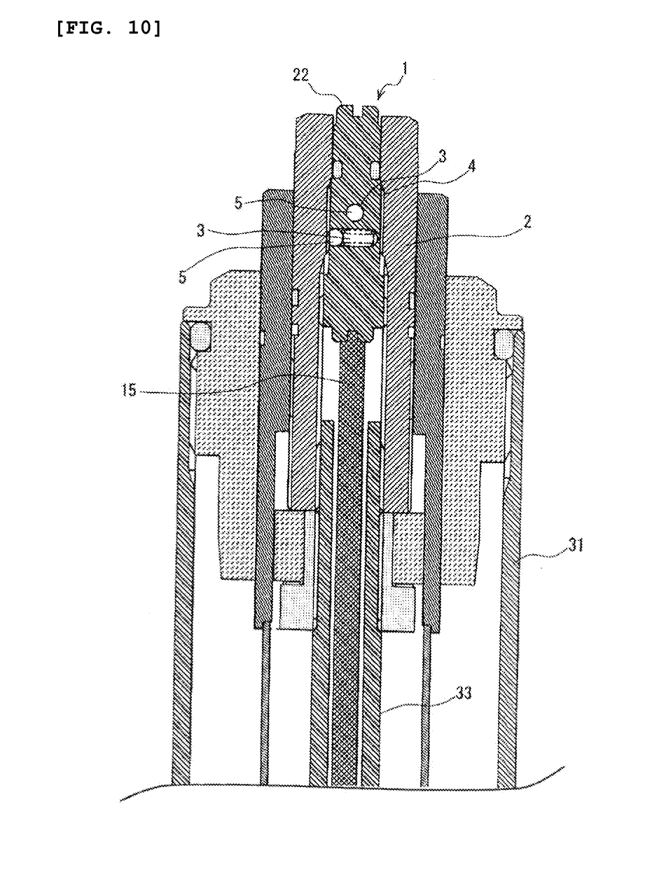

FIG. 9 is an enlarged cross-sectional view in a vicinity of the needle valve in FIG. 8. FIG. 10 is an enlarged cross-sectional view in a vicinity of the multistage adjusting device in FIG. 8.

An orifice member 34 can be provided at an end of the inner rod 33. The inner cylinder 32 can be defined into the contraction side oil chamber A and the expansion side oil chamber B by the piston 10 disposed here. A damping mechanism using the piston 10 in the front fork 28 is the same as that in the hydraulic damper on the rear wheel side illustrated in FIG. 3.

The damping force adjusting rod 15 can be axially and relatively movable in relation to the inner rod 33 and can be provided at an axial center of the inner rod 33. The needle valve 16, which can be generally in a conical shape, can be provided at an end of the adjusting rod 15.

The needle valve 16 changes an opening area of the small hole 17 of the orifice member 34 by the reciprocating movement of the adjusting rod 15. When the inner tube 30 is contracted, the oil in the contraction side oil chamber A flows in via the end of the orifice member 34 and moves from the bypass flow passage 18 to the expansion side oil chamber B through the small hole 17. Therefore, damping force can also be adjusted by adjusting an amount of the reciprocating movement of the needle valve 16. The needle valve 16 can be biased toward the expansion side by a spring 35.

The amount of reciprocating movement of this needle valve 16 can be adjusted by the various embodiments of the multistage adjusting devices 1 described above. The multistage adjusting device 1 can be provided at an end of the hydraulic damper 7.

In FIG. 10, two control members 3 disposed to orthogonally cross each other are illustrated. Here, the control members 3 each include only one ball 5. The adjuster 22 integrated with the control member 3 can be threadably connected to the cylindrical body 2 on which the groove 4 can be formed. The adjuster 22 rotates in the cylindrical body 2 and can be relatively movable in the axial direction.

A lower end of this adjuster 22 can be joined to the adjusting rod 15. Therefore, the adjuster 22 and the adjusting rod 15 rotate coaxially, and the adjusting rod 15 can be also movable in the axial direction. Therefore, the needle valve 16 provided at the end of the adjusting rod 15 can be also movable in the axial direction. As the needle valve 16 is be reciprocated, the opening area of the small hole 17 can be changed. As a result, control of damping force by the needle valve 16 can be enabled. The amount of reciprocating movement of the needle valve 16 can be adjusted by any of the embodiments of the multistage adjusting device described above and thus can be finely adjusted. Therefore, damping force can also be finely adjusted, and the finer performance setting can be made. Other constitutions and effects can be the same or similar to those in the examples applied to the hydraulic damper 7 from FIG. 3 to FIG. 6.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A multistage adjusting device, comprising:
a cylindrical body;
a plurality of grooves formed on an inner wall surface of the cylindrical body, the plurality of grooves being continuous or intermittent along a longitudinal direction of the cylindrical body;
a device main body provided with an adjusting body disposed in the cylindrical body and rotatable in an inner circumferential direction of the cylindrical body; and
at least first and second control members disposed along a longitudinal direction of the adjusting body;
the first and second control members being provided with at least a first and second balls, respectively, the first and second balls projecting from a side surface of the adjusting body and urged toward engagement with the grooves;
wherein the first and second control members are arranged such that at least first ball is located between adjacent grooves when the second ball is engaged with one of the grooves.

2. The multistage adjusting device according to claim 1, wherein at least the first control member includes at least a third ball, and is configured such that both of the first and third balls simultaneously engage first and second grooves of the plurality of grooves.

3. The multistage adjusting device according to claim 1, in combination with a hydraulic damper disposed between a frame and a wheel of a straddle-type vehicle, the hydraulic damper having a needle valve configured to adjust a damping effect of the hydraulic damper, the multistage adjusting device being configured to adjust an opening amount of the needle valve.

4. A multistage adjusting device, comprising:
a cylindrical body;
a plurality of grooves formed on an inner wall surface of the cylindrical body, the plurality of grooves being continuous or intermittent along a longitudinal direction of the cylindrical body;
a device main body provided with an adjusting body disposed in the cylindrical body and rotatable in an inner circumferential direction of the cylindrical body; and
at least first and second control members disposed along a longitudinal direction of the adjusting body, the first and second control members including first and second engagement means, respectively, for engaging the plurality of grooves;
wherein first and second engagement means are arranged such that at least the first engagement means is located between adjacent grooves when the second engagement means is engaged with one of the grooves.

5. The multistage adjusting device according to claim 4, in combination with a hydraulic damper disposed between a frame and a wheel of a straddle-type vehicle, the hydraulic damper having a needle valve configured to adjust a damping effect of the hydraulic damper, the multistage adjusting device being configured to adjust an opening amount of the needle valve.
